(19) United States
(12) Patent Application Publication
(10) Pub. No.: US 2025/0008202 A1
(43) Pub. Date: Jan. 2, 2025

(54) CONTENT GENERATION SYSTEM, CONTENT GENERATION METHOD, AND STORAGE MEDIUM

(71) Applicant: NEC Corporation, Minato-ku, Tokyo (JP)

(72) Inventor: Yukari ISHIKAWA, Tokyo (JP)

(73) Assignee: NEC Corporation, Minato-ku, Tokyo (JP)

(21) Appl. No.: 18/711,219

(22) PCT Filed: Feb. 15, 2023
(86) PCT No.: PCT/JP2023/005172

§ 371 Date: May 17, 2024

(30) Foreign Application Priority Data
Mar. 11, 2022 (JP) 2022-037799

(51) Int. Cl. H04N 21/854; G06F 3/04842; G06T 13/00; H04N 21/254

(52) U.S. Cl. CPC H04N 21/854; G06F 3/04842; G06T 13/00; H04N 21/2541

(57) ABSTRACT

A content generation system according to an aspect of the present disclosure includes: at least one memory storing a set of instructions; and at least one processor configured to execute the set of instructions to: display a material candidate including a basic material for which a usage right is granted from a higher-level organization of a target organization and an extension material for which the target organization holds a usage right independently of the higher-level organization in an order determined according to a designated job; receive a selected material selected from the material candidate; display an action candidate which is a candidate of an action of the selected material; receive a selected action selected from the action candidate; and generate a moving image in which the selected material performs the selected action.

### TECHNICAL FIELD

The present disclosure relates to a technology for generating a content.

### BACKGROUND ART

It is burdensome to repeatedly capture moving images in different situations in order to create a content of moving images of many patterns.

PTL 1 describes that middleware, an industry-specific framework, and components, which are software having different degrees of customization, are created and appropriately combined to construct software of a moving image system.

### CITATION LIST

### Patent Literature

PTL 1: JP 2002-358200 A

### SUMMARY OF INVENTION

### Technical Problem

The technology of PTL 1 can facilitate software construction but cannot facilitate content creation.

An object of the present disclosure is to provide a content generation system and the like that can facilitate creation of a content using a material usable by an organization.

### Solution to Problem

A content generation system according to an aspect of the present disclosure includes material display means that displays material candidates including a basic material for which a usage right is granted from a higher-level organization of a target organization and an extension material for which the target organization holds a usage right independently of the higher-level organization in an order determined according to a designated job, selected material receiving means that receives a selected material selected from the material candidates, action candidate display means that displays action candidates which are candidates of an action of the selected material, selected action receiving means that receives a selected action selected from the action candidates, and moving image generation means that generates a moving image in which the selected material performs the selected action.

A content generation method according to an aspect of the present disclosure includes displaying material candidates including a basic material for which a usage right is granted from a higher-level organization of a target organization and an extension material for which the target organization holds a usage right independently of the higher-level organization in an order determined according to a designated job, receiving a selected material selected from the material candidates, displaying action candidates which are candidates of an action of the selected material, receiving a selected action selected from the action candidates, and generating a moving image in which the selected material performs the selected action.

A program according to an aspect of the present disclosure causes a computer to execute material display processing of displaying material candidates including a basic material for which a usage right is granted from a higher-level organization of a target organization and an extension material for which the target organization holds a usage right independently of the higher-level organization in an order determined according to a designated job, selected material receiving processing of receiving a selected material selected from the material candidates, action candidate display processing of displaying action candidates which are candidates of an action of the selected material, selected action receiving processing of receiving a selected action selected from the action candidates, and moving image generation processing of generating a moving image in which the selected material performs the selected action. One aspect of the present disclosure is also implemented by a storage medium that stores the above-described program.

### Advantageous Effects of Invention

The present disclosure has an effect of facilitating creation of a content using a material usable by an organization.

### BRIEF DESCRIPTION OF DRAWINGS

FIG. 1 is a block diagram illustrating an example of a configuration of a content generation system according to a first example embodiment of the present disclosure.

FIG. 2 is a flowchart illustrating an example of an operation of the content generation system according to the first example embodiment of the present disclosure.

FIG. 3 is a block diagram illustrating an example of a configuration of a content generation system according to a second example embodiment of the present disclosure.

FIG. 4 is a flowchart illustrating an example of an operation of the content generation system according to the second example embodiment of the present disclosure.

FIG. 5 is a flowchart illustrating an example of an operation of a content generation system according to a second modified example of the second example embodiment of the present disclosure.

FIG. 6 is a flowchart illustrating the example of the operation of the content generation system according to the second modified example of the second example embodiment of the present disclosure.

FIG. 7 is a flowchart illustrating the example of the operation of the content generation system according to the second modified example of the second example embodiment of the present disclosure.

FIG. 8 is a diagram illustrating an example of a hardware configuration of a computer that can implement the content generation system according to the example embodiment of the present disclosure.

### EXAMPLE EMBODIMENT

Hereinafter, example embodiments of the present disclosure will be described in detail.

### First Example Embodiment

First, a content generation system according to a first example embodiment of the present disclosure will be described in detail with reference to the drawings.

### <Configuration>

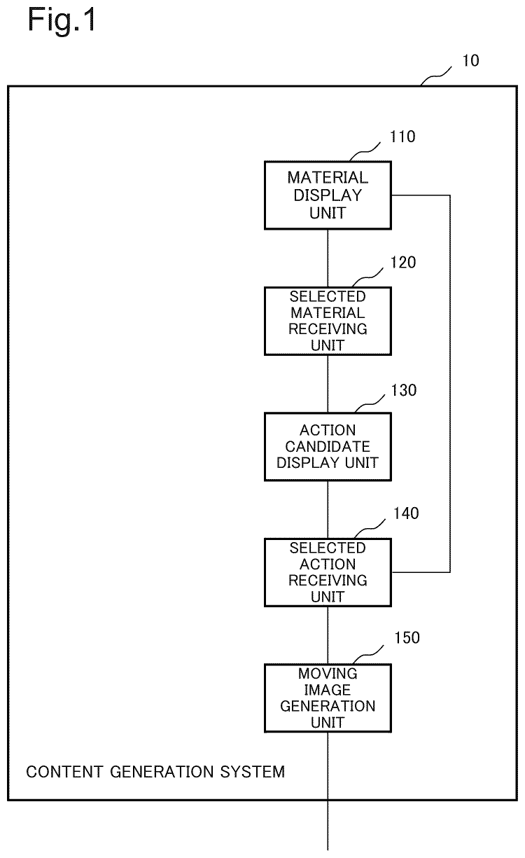

FIG. 1 is a block diagram illustrating an example of a configuration of the content generation system according to the first example embodiment of the present disclosure. In the example illustrated in FIG. 1, a content generation system 10 according to the present example embodiment includes a selected material receiving unit 120, an action candidate display unit 130 that displays action candidates that are candidates of an action of a selected material, a selected action receiving unit 140 that receives a selected action selected from the action candidates, and a moving image generation unit 150 that generates a moving image in which the selected material performs the selected action.

A material display unit 110 displays material candidates including a basic material for which a usage right is granted from a higher-level organization of a target organization and an extension material for which the target organization holds a usage right independently of the higher-level organization in the order determined according to a designated job. The selected material receiving unit 120 receives the selected material selected from the material candidates. The action candidate display unit 130 displays the action candidates that are candidates for the action of the selected material. The selected action receiving unit 140 receives the selected action selected from the action candidates. The moving image generation unit 150 generates the moving image in which the selected material performs the selected action.

The above-described material is, for example, data of a target such as a plurality of persons, a plurality of vehicles, a plurality of instruments, or the like. Specifically, the material is data used to generate a moving image in which the target is performing an action determined for the target in advance. Each of the materials is associated with a name representing the material. Each material is associated with identification information representing the material. The name of the material may be the identification information of the material. A specific example of the material will be described in detail below.

The material display unit 110 displays, for example, a material identification information list (for example, a material name list). The material display unit 110 may display, for example, a name of a material type. Then, in a case where any of the material types is designated by a user of the content generation system 10, for example, the selected material receiving unit 120 may receive information of the selected material type. The material display unit 110 may display the material identification information list included in the selected material type.

The target organization may be, for example, a department in a company. The higher-level organization may be, for example, a department including the target organization. The higher-level organization may be the company including the target department. The higher-level organization may be, for example, a national police agency.

In this case, the target organization may be a prefectural police headquarter or a department in a prefectural police headquarter. The higher-level organization may be, for example, a prefectural police headquarter. In this case, the target organization may be a department in the prefectural police headquarter. The target organization and the higher-level organization are not limited to the above examples.

The designated job is a job designated by the target organization. The order in which the target is displayed as the material may be appropriately determined by the user of the target organization, for example. The order in which the target is displayed as the material may be determined in advance based on, for example, a possibility (or frequency) of encountering the target in the designated job. The order in which the target is displayed as the material may be determined in advance based on, for example, an importance in the designated job. The order in which the target is displayed as the material may be determined in advance based on, for example, an importance of coping with the target in a case of encountering the target in the designated job. The order in which the target is displayed as the material may be determined in advance based on, for example, a possibility (or frequency) that the target is selected in content generation for the designated job. The order in which the target is displayed as the material is not limited to these examples.

In the present example embodiment, the action of the material is an action determined in advance as an action that the material may perform. The action of the material is determined in advance for each material type. The action candidate display unit 130 displays the action determined as the action of the selected material as the action candidate.

The order in which the action candidates are displayed may be appropriately determined by the user of the target organization, for example. The order in which the action candidates are displayed may be determined in advance based on a possibility that the target performs the action in a case of encountering the target in the designated job. The order in which the action candidates are displayed may be determined in advance based on an importance of coping with the target performing the action in a case where the target encountered in the designated job performs the action. The order in which the action candidates are displayed may be determined in advance based on, for example, a possibility (or frequency) of being selected as the action of the target in the content generation for the designated job. The order in which the action candidates are displayed is not limited to these examples.

The moving image generation unit 150 generates a moving image in which the selected material performs the selected action received by the selected action receiving unit 140 by using the data of the selected material.

### <Operation>

Next, an operation of the content generation system 10 according to the first example embodiment of the present disclosure will be described in detail with reference to the drawings.

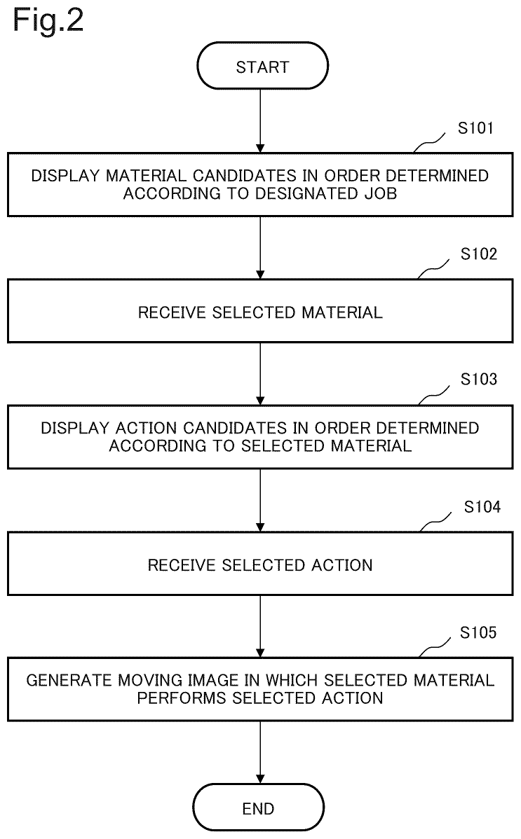

FIG. 2 is a flowchart illustrating an example of the operation of the content generation system 10 according to the first example embodiment of the present disclosure. In the example illustrated in FIG. 2, first, the material display unit 110 displays material candidates in the order determined according to a designated job (step S101). The selected material receiving unit 120 receives a selected material selected by the user of the content generation system 10 using an input device of the content generation system 10 (step S102). Specifically, the action candidate display unit 130 receives information indicating the selected material.

The action candidate display unit 130 displays action candidates in the order determined according to the selected material (step S103). The selected action receiving unit 140 receives a selected action selected by the user of the content generation system 10 using the input device of the content generation system 10 (step S104). Specifically, the selected action receiving unit 140 receives information indicating the selected action.

The moving image generation unit 150 generates a moving image in which the selected material performs the selected action (step S105). Then, the content generation system 10 ends the operation illustrated in FIG. 2.

### <Candidates>

The present disclosure has an effect of facilitating creation of a content using a material usable by an organization. The reason is that the selected material receiving unit 120 receives a selected material selected from the material candidates including the basic material for which the usage right is granted from the higher-level organization of the target organization and the extension material for which the target organization holds the usage right independently of the higher-level organization. In addition, the selected action receiving unit 140 receives a selected action selected from the action candidates that are candidates for the action of the selected material. Moreover, the moving image generation unit 150 generates a moving image in which the selected material performs the selected action.

### Modified Example of First Example Embodiment

The material may include a plurality of background images. The background image may be selected as another selected material, for example. In this case, for example, the material display unit 110 may display, for example, a plurality of background images included in the material as candidates before the start of the operation illustrated in FIG. 2. The selected material receiving unit 120 may further receive identification information of a designated background image. In this case, the moving image generation unit 150 may use the designated background image as a background image of the generated moving image. In this case, the action candidate display unit 130 does not have to display action candidates of the background image selected as the material.

Then, in step S105, the moving image generation unit 150 may use the selected background image as a background of a moving image in which a selected material performs a selected action. Furthermore, the content generation system 10 may repeat the operations from step S101 to step S104 a plurality of times. Then, in step S105, the moving image generation unit 150 may generate a moving image in which a plurality of selected materials perform selected actions.

### Specific Example of Material

The material may be modeled data (hereinafter, referred to as a model) so that the material performing the action described above can be expressed as a moving image. The model may be, for example, a three-dimensional model. The three-dimensional model may include data representing a three-dimensional shape and data representing a pattern of the surface. The three-dimensional model may include data representing a three-dimensional shape and data representing a pattern of the surface in various states during the action performed by the material. The three-dimensional model may include, for example, data representing a skeleton of the material (for example, a person), data representing a range of a motion of the skeleton, data of a shape of the surface that can be changed in accordance with the motion of the skeleton, and data representing a pattern of the surface. Then, the material may include data of definition of a motion of a joint or the like in a case where the material performs various actions defined for each material.

In this case, the moving image generation unit 150 may generate a moving image representing a video of the selected material that is represented as the three-dimensional model and performs the selected action from a preset viewpoint. In this case, a method for generating the video of the selected material that performs the selected action may be any of the existing methods for generating a video representing a target that is performing an action from a three-dimensional model of the target.

The material may be data of a moving image in which various targets perform predetermined various actions. The above-described material may be, for example, data of a plurality of images representing a process in which various targets perform predetermined various actions. In this case, an action candidate of the target may be an action of the target of which a moving image (or a plurality of images representing a process of the action) exists. The moving images (or a plurality of images) do not have to include background information. Specifically, pixels in a background region in the moving images (or a plurality of images) may be set to have pixel values determined in advance as pixel values of pixels in a region to be replaced with a background image to be combined, for example.

The material is, for example, a target that may be encountered during work. The action candidate is, for example, an action that may be performed by the target encountered during work. The basic material for which the usage right is granted from the higher-level organization is, for example, a target material that is likely to be commonly encountered by personnel belonging to the organization under the higher-level organization and is a material for which a usage right is granted to an organization under the higher-level organization. The extension material for which the target organization holds the usage right is, for example, a target material that is likely to be encountered by personnel belonging to the target organization and is a material for which a usage right is acquired by the target organization among materials other than the material for which the usage right is granted to an organization under the high-level organization.

Specific examples of the material include a material such as a person, a vehicle, or an instrument. In a case where the target organization is an organization in the police, the person may be, for example, a suspicious person, a vicious criminal, a drug seller, a drug addict, or the like. The instrument may be, for example, a weapon, a syringe, or the like. The action candidate in this case may be an action that requires a police officer to perform some sort of work action, such as an action of attacking a person, an action of hiding an object, or an action of escaping. The vehicle may be a vehicle encountered on a road, such as a bicycle, an automobile, or the like. The action in this case may be an action that requires a police officer to perform some sort of work action, such as an action of approaching, an action of escaping, or an action of performing a violation.

In a case where the target organization is a company, the person may be a suspicious person, a worker, or the like. Examples of the instrument include a weapon, a tool to be used, furniture in a factory, and equipment in a building. In a case where the person is a suspicious person, the action candidate may be, for example, an action determined as an action that may be performed by the suspicious person and that requires a security guard to take some sort of action, such as an action of stealing, an action of attacking, or an action of escaping. In a case where the person is a worker, the action candidate may be, for example, an action that requires treatment for the worker or the like, such as an action of falling down, an action of experiencing an accident, an action representing a state of suffering from various diseases, or an action of performing work. In a case where the target is an instrument, and the instrument is furniture in a factory or equipment in a building, an action of the instrument may be a state in which some treatment needs to be performed on the furniture or equipment, such as an abnormal state of the instrument or a process in which the instrument reaches an abnormal state. The person may be a visitor. In this case, the action candidate may be an action that may be performed by the visitor at the time of customer service, such as an action of asking various questions, an action of performing normal purchasing action, an action of performing suspicious action, a preliminary action of various crimes, an action of committing various crimes, an action of making a claim, and an intense action.

### Second Example Embodiment

Next, a second example embodiment of the present disclosure will be described in detail with reference to the drawings.

### <Configuration>

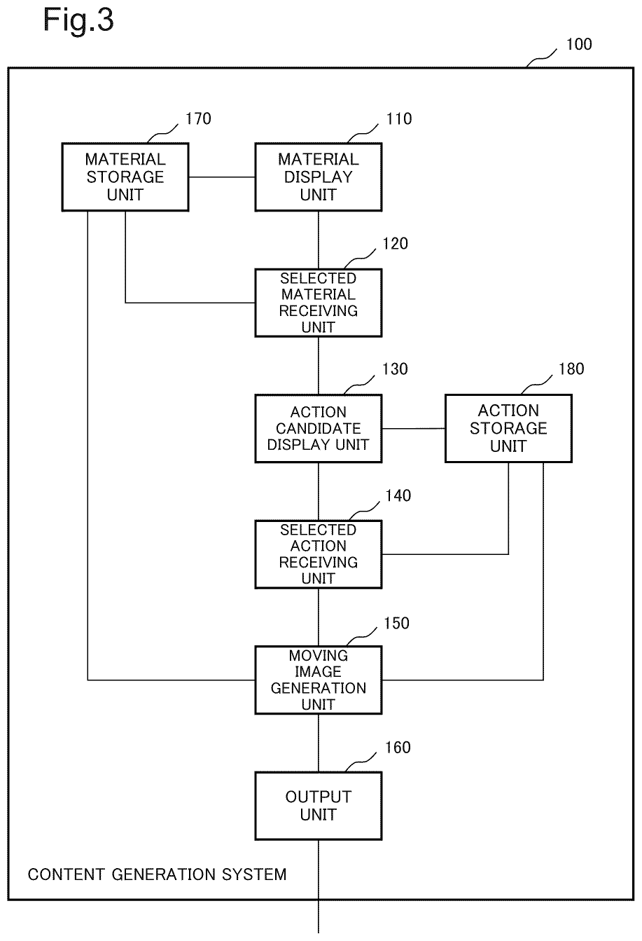

FIG. 3 is a block diagram illustrating an example of a configuration of a content generation system according to the second example embodiment of the present disclosure. In the example illustrated in FIG. 3, a content generation system 100 according to the present example embodiment includes a material display unit 110, a selected material receiving unit 120, an action candidate display unit 130, a selected action receiving unit 140, a moving image generation unit 150, an output unit 160, a material storage unit 170, and an action storage unit 180. The material display unit 110, the selected material receiving unit 120, the action candidate display unit 130, the selected action receiving unit 140, and the moving image generation unit 150 according to the present example embodiment have the same functions and operate similarly as the material display unit 110, the selected material receiving unit 120, the action candidate display unit 130, the selected action receiving unit 140, and the moving image generation unit 150 according to the first example embodiment, respectively. Hereinafter, differences between the present example embodiment and the first example embodiment will be mainly described.

### <Material Storage Unit 170>

The material storage unit 170 stores a basic material and a selected material. The material storage unit 170 may include a storage unit that stores the basic material and a storage unit that stores the selected material. At least one of the storage unit that stores the basic material or the storage unit that stores the selected material may be implemented in a storage connected to the content generation system 100 via a communication network.

The material storage unit 170 may store information indicating the order of displaying the materials.

### <Action Storage Unit 180>

The action storage unit 180 stores action candidates (specifically, data of action candidates of the basic material) of the basic material and action candidates (specifically, data of action candidate of the selected material) of the selected material. The action storage unit 180 may include a storage unit that stores the action candidates of the basic material and a storage unit that stores the action candidates of the selected material. At least one of the storage unit that stores the action candidate of the basic material or the storage unit that stores the action candidate of the selected material may be implemented in a storage connected to the content generation system 100 via a communication network.

The action storage unit 180 may store the order of displaying the action candidates for each material.

### <Material Display Unit 110>

The material display unit 110 displays information indicating the basic material and an extension material stored in the material storage unit 170 in the order of displaying the material including the basic material and the extension material determined for a target organization.

### <Selected Material Receiving Unit 120>

The selected material receiving unit 120 receives information indicating the selected material which is a material selected from the basic material and the extension material whose information is displayed on the material display unit 110. The selected material receiving unit 120 transmits the information indicating the received selected material to the action candidate display unit 130.

### <Action Candidate Display Unit 130>

The action candidate display unit 130 receives the information indicating the selected material from the selected material receiving unit 120. The action candidate display unit 130 displays information indicating the action candidates stored in the action storage unit 180 as the action candidates of the selected material whose information is received, in the order of displaying the action candidates of the selected material determined for the target organization. The action candidate display unit 130 transmits the information indicating the selected material to the selected action receiving unit 140.

### <Selected Action Receiving Unit 140>

The selected action receiving unit 140 receives the information indicating the selected material from the action candidate display unit 130. The selected action receiving unit 140 receives information indicating the selected action that is an action candidate selected from the action candidates whose information is displayed on the action candidate display unit 130. The selected action receiving unit 140 transmits the information indicating the selected material and the information indicating the selected action to the moving image generation unit 150.

### <Moving Image Generation Unit 150>

The moving image generation unit 150 receives the information indicating the selected material and the information indicating the selected action from the selected action receiving unit 140. The moving image generation unit 150 reads, from the material storage unit 170 and the action storage unit 180, data to be used for generating a moving image in which the selected material performs the selected action.

For example, in a case where the information of the material is represented by the above-described three-dimensional model, information of the three-dimensional model of the material is stored in the material storage unit 170. Then, information indicating an action of the three-dimensional model of the material that performs the action as the action candidate may be stored in the action storage unit 180. In this case, the moving image generation unit 150 reads the information of the selected material from the material storage unit 170, and reads information indicating the three-dimensional model of the selected material that performs the action as the action candidate from the action storage unit 180.

The information indicating the action of the three-dimensional model of the material that performs the action as the action candidate may also be stored in the material storage unit 170. In this case, the moving image generation unit 150 reads, from the material storage unit 170, data to be used for generating a moving image in which the selected material performs the selected action.

In a case where the information of the material is a moving image (or a plurality of still images) in which the material performs the action as the action candidate, the information of the material may be stored in the material storage unit 170. Also in this case, the moving image generation unit 150 reads, from the material storage unit 170, data to be used for generating a moving image in which the selected material performs the selected action.

The moving image generation unit 150 generates a moving image in which the selected material performs the selected action by using the read data to be used for generating a moving image in which the selected material performs the selected action. The moving image generation unit 150 transmits the generated moving image to the output unit 160.

### <Output Unit 160>

The output unit 160 receives the moving image and outputs the received moving image to an output device. The output device may be, for example, at least one of a display device, a storage device included in the content generation system 100, or another device communicably connected to the content generation system 100 via a communication network. The another device communicably connected to the content generation system 100 via the communication network is, for example, an information processing device or a device such as a storage.

### <Operation>

Next, an example of an operation of the content generation system 100 according to the second example embodiment of the present disclosure will be described in detail with reference to the drawings.

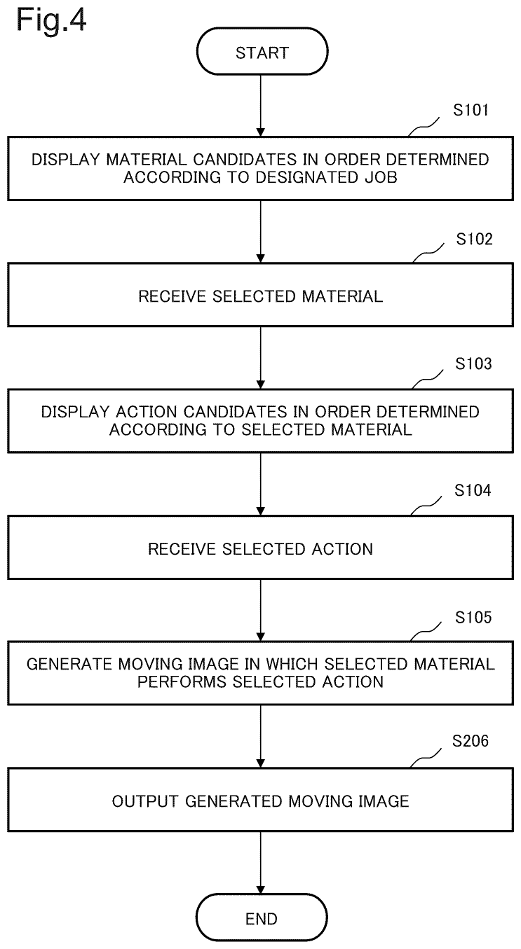

FIG. 4 is a flowchart illustrating an example of the operation of the content generation system 100 according to the second example embodiment of the present disclosure. In the example illustrated in FIG. 4, the operations from step S101 to step S105 are the same as the operations from step S101 to step S105 of the content generation system according to the first example embodiment. In step S206, the output unit 160 outputs the generated moving image.

### Effects

The present example embodiment described above has the same effect as that of the first example embodiment. The reason is the same as the reason why the effects of the first example embodiment are exhibited.

### First Modified Example of Second Example Embodiment

The material storage unit 170 may store the order of displaying the materials for each target organization.

The material display unit 110 may receive, for example, information of the target organization designated by the user of the content generation system 100. The material display unit 110 may display the information of the material in the order of displaying the materials in a case where the target organization is the designated target organization.

The action storage unit 180 may store the order of displaying the actions for each material for each target organization.

The action candidate display unit 130 may display the action candidates of the selected material in the order of displaying the action candidates of the selected material in a case where the target organization is the designated target organization.

### Second Modified Example of Second Example Embodiment

Next, a second modified example of the second example embodiment of the present disclosure will be described in detail with reference to the drawings. A configuration of a content generation system 100 according to the present modified example is the same as the configuration of the content generation system 100 according to the second example embodiment illustrated in FIG. 3. In the present modified example, a material includes data of a target that performs an action on another target.

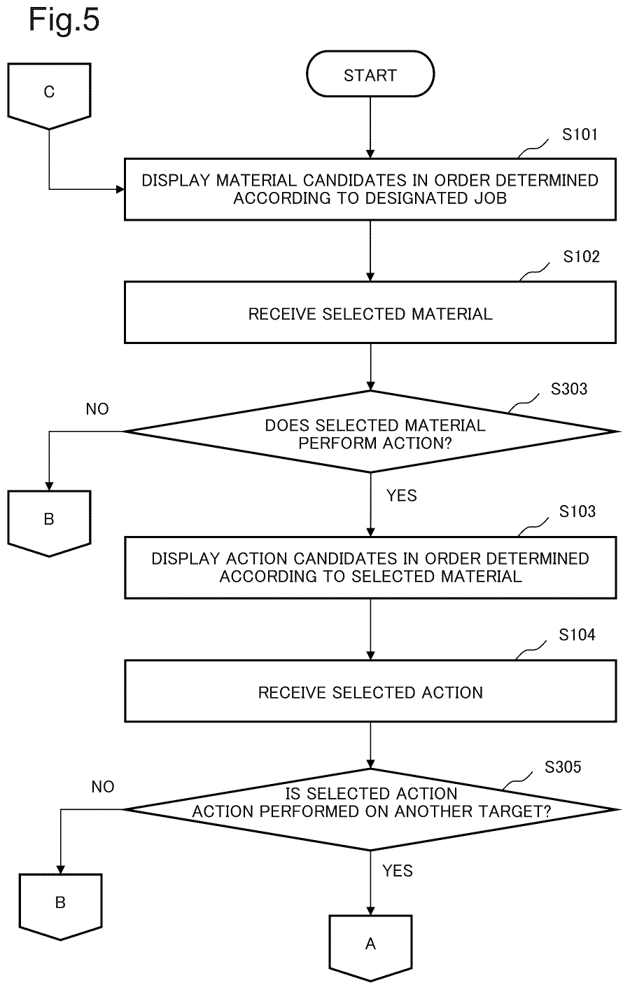

FIGS. 5, 6, and 7 are flowcharts illustrating an example of an operation of the content generation system 100 according to the second modified example of the second example embodiment of the present disclosure.

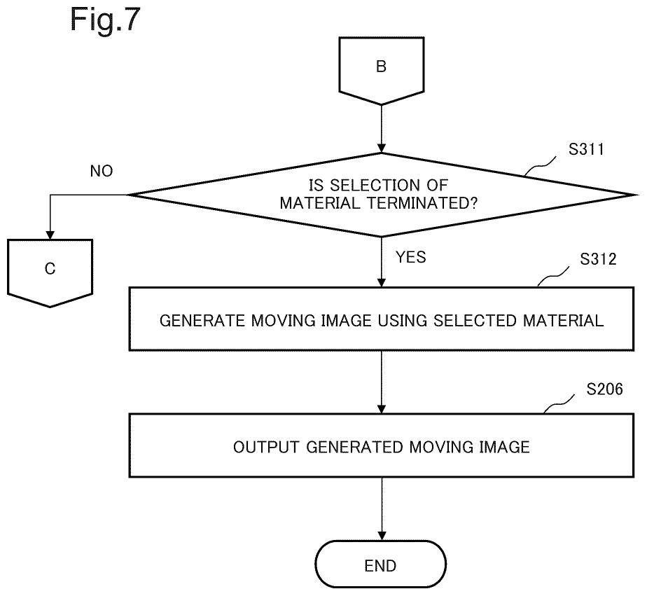

The content generation system 100 according to the present modified example first displays material candidates in the order determined according to a designated job (step S101 in FIG. 5). Next, a selected material receiving unit 120 receives a selected material (step S102). In a case where the selected material is a material that performs an action (NO in step S303), the operation of the content generation system 100 proceeds to B of FIG. 7. That is, next, the content generation system 100 performs the operation of step S11l in FIG. 7. The selected material that does not perform the action described above is, for example, a background image.

In a case where the selected material is a material that performs an action (YES in step S303), an action candidate display unit 130 displays action candidates in the order determined according to the selected material (step S103). A selected action receiving unit 140 receives a selected action (step S104). In a case where the selected action is not an action performed on another target (NO in step S305), the operation of the content generation system 100 proceeds to B in FIG. 7.

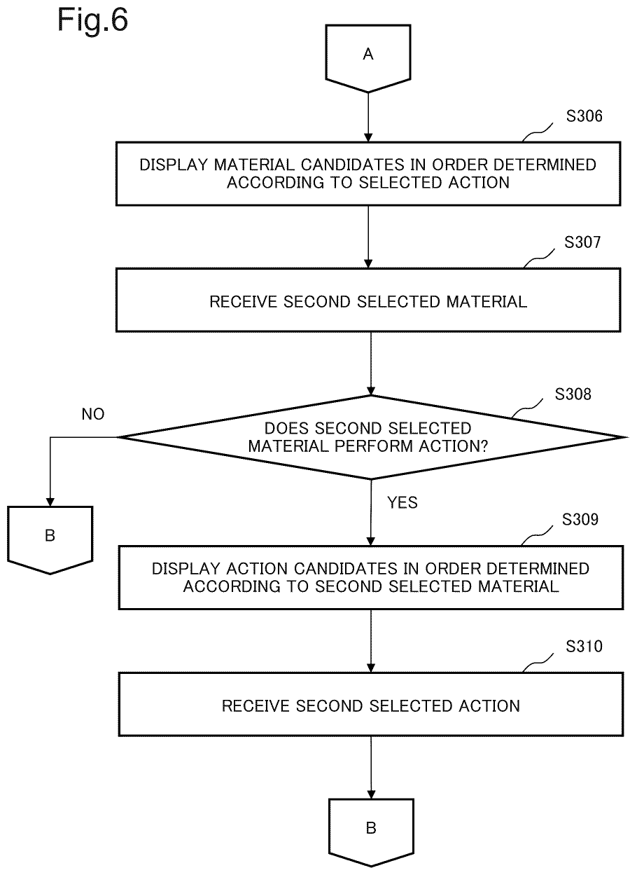

In a case where the selected action is an action performed on another target (YES in step S305), the operation of the content generation system 100 proceeds to A in FIG. 6. That is, next, the content generation system 100 performs the operation of step S306 in FIG. 6.

In step S306 of FIG. 6, the material display unit 110 displays material candidates in the order determined according to the selected action (step S306). The material candidates displayed in the order determined according to the selected action are materials determined in advance as materials that can be targets of the selected action of the selected material. The material candidates displayed in the order determined according to the selected action are, for example, materials determined in advance as target materials that can be used in the selected action of the selected material. The material candidates displayed in the order determined according to the selected action are, for example, materials determined in advance as target materials that can be targets of the selected action of the selected material. The material candidates displayed in the order determined according to the selected action displayed in step S306 are not limited to these examples. The material candidates displayed in the order determined according to the selected action displayed in step S306 may be appropriately determined in advance for the selected action.

Next, the selected material receiving unit 120 receives a second selected material which is a material selected from the material candidates displayed in the order determined according to the selected action (step S307). In a case where the second selected material does not perform an action (NO in step S308), that is, in a case where action candidates as actions that can be performed by the second selected material are not determined in advance, the operation of the content generation system 100 proceeds to B in FIG. 7. That is, next, the content generation system 100 performs the operation of step S111 in FIG. 7.

In a case where the second selected material performs an action (YES in step S308), that is, in a case where the action candidates of the second selected material are determined in advance, the action candidate display unit 130 displays the action candidates in the order determined according to the second selected material (step S309). The selected action receiving unit 140 receives a second selected action which is an action candidate selected from the action candidates displayed as the action candidates of the second selected material (step S310). Then, the operation of the content generation system 100 proceeds to B in FIG. 7. That is, next, the content generation system 100 performs the operation of step S311 in FIG. 7.

In a case where the operation of the content generation system 100 proceeds to B in FIG. 7, the operation after step S311 is performed. In a case where the selection of the material is not terminated (NO in step S311), for example, in a case where the user of the content generation system 100 does not instruct to terminate the selection of the material, the operation of the content generation system 100 returns to C in FIG. 5. That is, the content generation system then repeats the operation from step S101.

In a case where the selection of the material is terminated (NO in step S311), for example, in a case where the user of the content generation system 100 instructs to terminate the selection of the material, a moving image generation unit 150 generates a moving image using the selected material (step S312).

In the present modified example, in a case where a plurality of selected materials are selected, the moving image generation unit 150 generates a moving image using the plurality of selected materials. In a case where a background image is selected as the selected material, the moving image generation unit 150 uses the background image as a background image of the moving image to be generated. In a case where a material of a target (hereinafter, referred to as an action subject) that performs a selected action is selected as the selected material, the moving image generation unit 150 generates, for example, a moving image representing a scene where the action subject performs a selected action. In a case where materials of a plurality of action subjects are selected, the moving image generation unit 150 generates a moving image in which the plurality of action subjects perform selected actions. In a case where a material of an action subject and a material (that is, the second selected material described above) of a target (hereinafter, referred to as an action target) of a selected action of the action subject are selected, the moving image generation unit 150 generates, for example, a moving image in which the action subject performs the selected action on the action target. Furthermore, in a case where a selected action of an action target is selected, the moving image generation unit 150 may generate, for example, a moving image in which the action target performs the selected action of the action target in a process in which an action subject performs a selected action on the action target.

Finally, an output unit 160 outputs the generated moving image (step S206).

### Other Example Embodiments

The content generation system according to the example embodiment of the present disclosure can be implemented by a computer including a processor that executes a program loaded from a storage medium into a memory. The content generation system according to the example embodiment of the present disclosure can be implemented by dedicated hardware. The content generation system according to the example embodiment of the present disclosure can be implemented by a combination of the above-described computer and dedicated hardware.

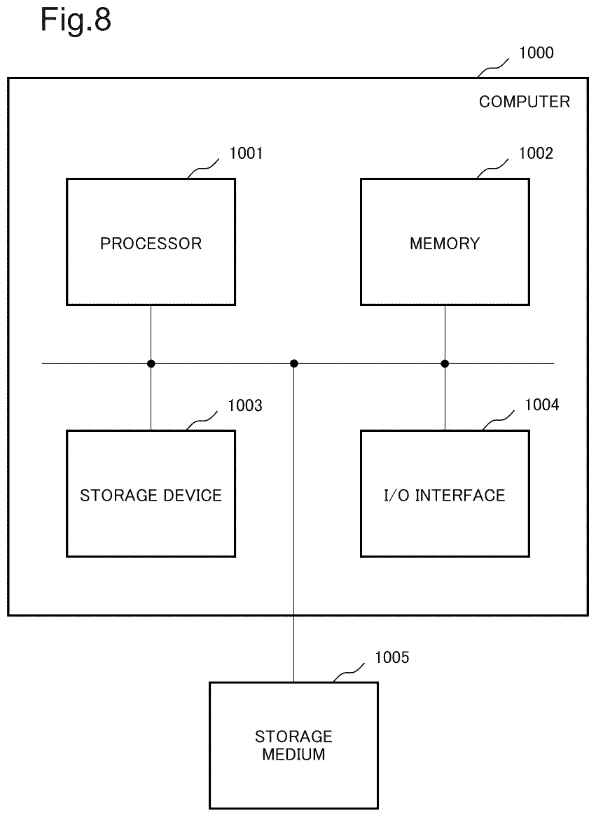

FIG. 8 is a diagram illustrating an example of a hardware configuration of a computer 1000 that can implement the content generation system according to the example embodiment of the present disclosure. In the example illustrated in FIG. 8, the computer 1000 includes a processor 1001, a memory 1002, a storage device 1003, and an input/output (I/O) interface 1004. In addition, the computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and in the memory 1002 and the storage device 1003. The processor 1001 can access, for example, a device as an output destination of a moving image via the I/O interface 1004. The processor 1001 can access the storage medium 1005. The storage medium 1005 stores a program for operating the computer 1000 as the content generation system according to the example embodiment of the present disclosure.

The processor 1001 loads, into the memory 1002, a program that is stored in the storage medium 1005 and causes the computer 1000 to operate as the content generation system according to the example embodiment of the present disclosure. Then, the processor 1001 executes the program loaded into the memory 1002, whereby the computer 1000 operates as the content generation system according to the example embodiment of the present disclosure.

The material display unit 110, the selected material receiving unit 120, the action candidate display unit 130, the selected action receiving unit 140, the moving image generation unit 150, and the output unit 160 can be implemented by, for example, the processor 1001 that executes a program loaded in the memory 1002. The material storage unit 170 and the action storage unit 180 can be implemented by the memory 1002 included in the computer 1000 and the storage device 1003 such as a hard disk device. Some or all of the material display unit 110, the selected material receiving unit 120, the action candidate display unit 130, the selected action receiving unit 140, the moving image generation unit 150, the output unit 160, the material storage unit 170, and the action storage unit 180 can be implemented by a dedicated circuit that implements the functions of the units.

Some or all of the above-described example embodiments can also be described as the following Supplementary Notes, but are not limited thereto.

### Supplementary Note 1

A content generation system including:
a material display unit configured to display a material candidate including a basic material for which a usage right is granted from a higher-level organization of a target organization and an extension material for which the target organization holds a usage right independently of the higher-level organization in an order determined according to a designated job;
a selected material receiving unit configured to receive a selected material selected from the material candidate;
an action candidate display unit configured to display an action candidate which are candidates of an action of the selected material;
a selected action receiving unit configured to receive a selected action selected from the action candidate; and
a moving image generation unit configured to generate a moving image in which the selected material performs the selected action.

### Supplementary Note 2

The content generation system according to Supplementary Note 1, in which
the action candidate display unit displays the action candidate including a basic action candidate which is the action candidate for which a usage right is granted by the higher-level organization and an extension action candidate which is the action candidate for which the target organization holds a usage right independently of the higher-level organization, and
the selected action receiving unit receives the selected action selected from the action candidate including the basic action candidate and the extension action candidate.

### Supplementary Note 3

The content generation system according to Supplementary Note 1 or 2, in which
the action candidate display unit displays the action candidate in an order determined according to the designated job.

### Supplementary Note 4

The content generation system according to any one of Supplementary Notes 1 to 3, in which
the material display unit displays the material candidate and a selected background image,
the selected material receiving unit receives, as the selected material, a material candidate dragged on the background image,
the action candidate display unit displays the action candidate of the material candidate when the material candidate is dragged on the background image, and
the moving image generation unit generates a moving image in which the selected material performs the selected action at a place to which the material candidate received as the selected material is dragged in the background image.

### Supplementary Note 5

The content generation system according to Supplementary Note 4, in which
the action candidate display unit displays the action candidate of the selected material when a region of the selected material displayed at the place to which the material candidate received as the selected material is dragged in the background image is designated.

### Supplementary Note 6

The content generation system according to any one of Supplementary Notes 1 to 5, in which
the material candidate includes a plurality of types of persons, a plurality of types of vehicles, and a plurality of types of instruments,
the action candidate of the material candidate that is a person includes a motion, a change in expression, and a voice, and
the selected material receiving unit receives a material candidate selected as a target of the selected action from the plurality of types of instruments as a second selected material in a case where the selected material selected from the plurality of types of persons is received and the selected action for an instrument as the target is received.

### Supplementary Note 7

A content generation method including:
displaying a material candidate including a basic material for which a usage right is granted from a higher-level organization of a target organization and an extension material for which the target organization holds a usage right independently of the higher-level organization in an order determined according to a designated job;
receiving a selected material selected from the material candidate;
displaying an action candidate which are candidates of an action of the selected material;
receiving a selected action selected from the action candidate; and
generating a moving image in which the selected material performs the selected action.

### Supplementary Note 8

The content generation method according to Supplementary Note 7, further including:
displaying the action candidate including a basic action candidate which is the action candidate for which a usage right is granted by the higher-level organization and an extension action candidate which is the action candidate for which the target organization holds a usage right independently of the higher-level organization; and
receiving the selected action selected from the action candidate including the basic action candidate and the extension action candidate.

### Supplementary Note 9

The content generation method according to Supplementary Note 7 or 8, further including
displaying the action candidate in an order determined according to the designated job.

### Supplementary Note 10

The content generation method according to any one of Supplementary Notes 7 to 9, further including:
displaying the material candidate and a selected background image;
receiving, as the selected material, a material candidate dragged on the background image;
displaying the action candidate of the material candidate when the material candidate is dragged on the background image; and
generating a moving image in which the selected material performs the selected action at a place to which the material candidate received as the selected material is dragged in the background image.

### Supplementary Note 11

The content generation method according to Supplementary Note 10, further including
displaying the action candidate of the selected material when a region of the selected material displayed at the place to which the material candidate received as the selected material is dragged in the background image is designated.

### Supplementary Note 12

The content generation method according to any one of Supplementary Notes 7 to 11, in which
the material candidate includes a plurality of types of persons, a plurality of types of vehicles, and a plurality of types of instruments,
the action candidate of the material candidate that is a person includes a motion, a change in expression, and a voice, and
the content generation method further includes receiving a material candidate selected as a target of the selected action from the plurality of types of instruments as a second selected material in a case where the selected material selected from the plurality of types of persons is received and the selected action for an instrument as the target is received.

### Supplementary Note 13

A program for causing a computer to execute:
material display processing of displaying material candidate including a basic material for which a usage right is granted from a higher-level organization of a target organization and an extension material for which the target organization holds a usage right independently of the higher-level organization in an order determined according to a designated job;
selected material receiving processing of receiving a selected material selected from the material candidate;
action candidate display processing of displaying an action candidate which are candidates of an action of the selected material;
selected action receiving processing of receiving a selected action selected from the action candidate; and
moving image generation processing of generating a moving image in which the selected material performs the selected action.

### Supplementary Note 14

The program according to Supplementary Note 13, in which
in the action candidate display processing, the action candidate including a basic action candidate which is the action candidate for which a usage right is granted by the higher-level organization and an extension action candidate which is the action candidate for which the target organization holds a usage right independently of the higher-level organization are displayed, and
in the selected action receiving processing, the selected action selected from the action candidate including the basic action candidate and the extension action candidate is received.

### Supplementary Note 15

The program according to Supplementary Note 13 or 14, in which
in the action candidate display processing, the action candidate are displayed in an order determined according to the designated job.

### Supplementary Note 16

The program according to any one of Supplementary Notes 13 to 15, in which
in the material display processing, the material candidate and a selected background image are displayed,
in the selected material receiving processing, a material candidate dragged on the background image is received as the selected material,
in the action candidate display processing, the action candidate of the material candidate is displayed when the material candidate is dragged on the background image, and
in the moving image generation processing, a moving image in which the selected material performs the selected action at a place to which the material candidate received as the selected material is dragged in the background image is generated.

### Supplementary Note 17

The program according to Supplementary Note 16, in which
in the action candidate display processing, the action candidate of the selected material is displayed when a region of the selected material displayed at the place to which the material candidate received as the selected material is dragged in the background image is designated.

### Supplementary Note 18

The program according to any one of Supplementary Notes 13 to 17, in which
the material candidate includes a plurality of types of persons, a plurality of types of vehicles, and a plurality of types of instruments,
the action candidate of the material candidate that is a person includes a motion, a change in expression, and a voice, and
in the selected material receiving processing, a material candidate selected as a target of the selected action from the plurality of types of instruments is received as a second selected material in a case where the selected material selected from the plurality of types of persons is received and the selected action for an instrument as the target is received.

While the present disclosure has been particularly shown and described with reference to example embodiments thereof, the present disclosure is not limited to these embodiments. It will be understood by those of ordinary skill in the art that various changes in form and details may be made therein without departing from the spirit and scope of the present disclosure as defined by the claims.

This application is based upon and claims the benefit of priority from Japanese patent application No. 2022-037799, filed on Mar. 11, 2022, the disclosure of which is incorporated herein in its entirety by reference.

### REFERENCE SIGNS LIST

10 content generation system
100 content generation system
110 material display unit
120 selected material receiving unit
130 action candidate display unit
140 selected action receiving unit
150 moving image generation unit
160 output unit
170 material storage unit
180 action storage unit
1000 computer
1001 processor
1002 memory
1003 storage device
1004 I/O interface
1005 storage medium

What is claimed is:

1. A content generation system comprising:
at least one memory storing a set of instructions; and
at least one processor configured to execute the set of instructions to;
display a material candidate including a basic material for which a usage right is granted from a higher-level organization of a target organization and an extension material for which the target organization holds a usage right independently of the higher-level organization in an order determined according to a designated job;
receive a selected material selected from the material candidate;
display an action candidate which is a candidate of an action of the selected material;
receive a selected action selected from the action candidate; and
generate a moving image in which the selected material performs the selected action.

2. The content generation system according to claim 1, wherein
the at least one processor is further configured to execute the instructions to;
display the action candidate including a basic action candidate and an extension action candidate, the basic action candidate being the action candidate for which a usage right is granted by the higher-level organization, the extension action candidate being the action candidate for which the target organization holds a usage right independently of the higher-level organization, and
receive the selected action selected from the action candidate including the basic action candidate and the extension action candidate.

3. The content generation system according to claim 1, wherein
the at least one processor is further configured to execute the instructions to display the action candidate in an order determined according to the designated job.

4. The content generation system according to claim 1, wherein
the at least one processor is further configured to execute the instructions to;
display the material candidate and a selected background image;
receive, as the selected material, a material candidate dragged on the background image;
display the action candidate of the material candidate when the material candidate is dragged on the background image; and
generate a moving image in which the selected material performs the selected action at a place to which the material candidate received as the selected material is dragged in the background image.

5. The content generation system according to claim 4, wherein
the at least one processor is further configured to execute the instructions to display the action candidate of the selected material when a region of the selected material is designated, the selected material being displayed at the place to which the material candidate received as the selected material is dragged in the background image.

6. The content generation system according to claim 1, wherein
the material candidate includes a plurality of types of persons, a plurality of types of vehicles, and a plurality of types of instruments,
the action candidate of the material candidate that is a person includes a motion, a change in expression, and a voice, and
the at least one processor is further configured to execute the instructions to receive a material candidate selected as a target of the selected action from the plurality of types of instruments as a second selected material in a case where the selected material selected from the plurality of types of persons is received and the selected action for an instrument as the target is received.

7. A content generation method comprising:
displaying a material candidate including a basic material for which a usage right is granted from a higher-level organization of a target organization and an extension material for which the target organization holds a usage right independently of the higher-level organization in an order determined according to a designated job;
receiving a selected material selected from the material candidate;
displaying an action candidate which is a candidate of an action of the selected material;
receiving a selected action selected from the action candidate; and
generating a moving image in which the selected material performs the selected action.

8. The content generation method according to claim 7, further comprising:
displaying the action candidate including a basic action candidate and an extension action candidate, the basic action candidate being the action candidate for which a usage right is granted by the higher-level organization, the extension action candidate being the action candidate for which the target organization holds a usage right independently of the higher-level organization; and
receiving the selected action selected from the action candidate including the basic action candidate and the extension action candidate.

9. The content generation method according to claim 7, further comprising
displaying the action candidate in an order determined according to the designated job.

10. The content generation method according to claim 7, further comprising:
displaying the material candidate and a selected background image;
receiving, as the selected material, a material candidate dragged on the background image;
displaying the action candidate of the material candidate when the material candidate is dragged on the background image; and
generating a moving image in which the selected material performs the selected action at a place to which the material candidate received as the selected material is dragged in the background image.

11. The content generation method according to claim 10, further comprising
displaying the action candidate of the selected material when a region of the selected material is designated, the selected material being displayed at the place to which the material candidate received as the selected material is dragged in the background image.

12. The content generation method according to claim 7, wherein
the material candidate includes a plurality of types of persons, a plurality of types of vehicles, and a plurality of types of instruments,
the action candidate of the material candidate that is a person includes a motion, a change in expression, and a voice, and
the content generation method further comprises receiving a material candidate selected as a target of the selected action from the plurality of types of instruments as a second selected material in a case where the selected material selected from the plurality of types of persons is received and the selected action for an instrument as the target is received.

13. A non-transitory storage medium storing a program for causing a computer to execute:
material display processing of displaying a material candidate including a basic material for which a usage right is granted from a higher-level organization of a target organization and an extension material for which the target organization holds a usage right independently of the higher-level organization in an order determined according to a designated job;
selected material receiving processing of receiving a selected material selected from the material candidate;
action candidate display processing of displaying an action candidate which is a candidate of an action of the selected material;
selected action receiving processing of receiving a selected action selected from the action candidate; and
moving image generation processing of generating a moving image in which the selected material performs the selected action.

14. The non-transitory storage medium according to claim 13, wherein
the action candidate display processing displays the action candidate including a basic action candidate and an extension action candidate, the basic action candidate being the action candidate for which a usage right is granted by the higher-level organization, the extension action candidate being the action candidate for which the target organization holds a usage right independently of the higher-level organization, and
the selected action receiving processing receives the selected action selected from the action candidate including the basic action candidate and the extension action candidate.

15. The non-transitory storage medium according to claim 13, wherein
the action candidate display processing displays the action candidate in an order determined according to the designated job.

16. The non-transitory storage medium according to claim 13, wherein
the material display processing display the material candidate and a selected background image,
the selected material receiving processing receives a material candidate dragged on the background image i as the selected material,
the action candidate display processing displays the action candidate of the material candidate when the material candidate is dragged on the background image, and
the moving image generation processing generates a moving image in which the selected material performs the selected action at a place to which the material candidate received as the selected material is dragged in the background image.

17. The non-transitory storage medium according to claim 16, wherein
the action candidate display processing displays the action candidate of the selected material when a region of the selected material is designated, the selected material being displayed at the place to which the material candidate received as the selected material is dragged in the background image.

18. The non-transitory storage medium according to claim 13, wherein
the material candidate includes a plurality of types of persons, a plurality of types of vehicles, and a plurality of types of instruments,
the action candidate of the material candidate that is a person includes a motion, a change in expression, and a voice, and
the selected material receiving processing receives a material candidate selected as a target of the selected action from the plurality of types of instruments as a second selected material in a case where the selected material selected from the plurality of types of persons is received and the selected action for an instrument as the target is received.
